(19) United States
(12) Patent Application Publication
(10) Pub. No.: US 2011/0289776 A1
(43) Pub. Date: Dec. 1, 2011

(54) Fluid Dispensing Hair Removal Device

(76) Inventors: Christopher Martin Hawes, Reading (GB); Lee Burrowes, Horsell (GB)

(21) Appl. No.: 13/085,660

(22) Filed: Apr. 13, 2011

Related U.S. Application Data
(60) Provisional application No. 61/324,449, filed on Apr. 15, 2010.

(51) Int. Cl. B26B 21/44

(52) U.S. Cl. 30/41

(57) ABSTRACT

A hair removal device comprising: a handle; a head positioned on one end of the handle, said hair removal device having a pivot axis about which said head is mounted; one or more orifice(s) in the skin-facing surface of the head are positioned at or close to the pivot axis; a collapsible reservoir suitable for containing a fluid to be dispensed during use of the hair removal device through said one or more orifice(s); an enclosure system selected from a deformable rigid container or a non-deformable rigid container.

### CROSS REFERENCE TO RELATED APPLICATIONS

This application claims the benefit of U.S. Provisional Application No. 61/324,449 filed Apr. 15, 2010.

### BACKGROUND OF THE INVENTION

Hair removal devices capable of dispensing a fluid, such as a shaving preparation or a lubricant are known, but have a number of shortcomings

A problem associated with some prior art fluid-dispensing razors is that the fluid is loaded directly into a reservoir disposed within the razor such that, on dispensing, it may be replaced by and come into contact with ambient air or, alternatively, it may directly contact the dispensing mechanism. These kinds of executions raise the prospect of contamination, which, for a device such as a razor, is a problem that must be avoided, especially if fluid remains in the razor between shaves, allowing microbial build-up. Such an execution is known from WO 05/058560 A1.

FR-A-2 629 385 discloses a razor having an aerosol cartridge. Such devices are complex and expensive to produce. They also pollute the atmosphere with propellants and, in addition, aerosol canisters are generally not reusable, so must also be disposed of as well. This patent application also suggests replacing the pressurized cartridge with a liquid pump, but provides no details of either how to achieve that, or how to do so in a manner that maintains the product to be dispensed sterile.

WO 05/058560 A1 discloses a fluid dispensing razor having a flexible bladder filled with shaving aid located in the handle. On actuating a button in the handle, a ratchet mechanism advances a piston which compresses the bladder to expel shaving aid through holes located around the shaving blades. This execution is mechanically complex to manufacture and has the disadvantage that the non-uniform application of pressure on the bladder may result in the accumulation of shaving aid in volumes where the pressure is lower, thereby resulting in incomplete emptying of the bladder during use.

WO 05/065897 discloses an arrangement comprising a bladder filled with shaving aid. A pinch roller driven by a drive mechanism serves to compress the bladder and expel the shaving aid. This arrangement is technically very complex.

Reference can also be made to GB 2 246 314 A, which teaches a razor in which a tubular sack of soap is disposed in the handle. Upon squeezing pressure plates in the handle, spring plates are, in turn, pressurized which squeeze the sack to force soap through holes in the shaving head. Once again, the non-uniform application of pressure to the external surface of the sack, may cause soap to accumulate in volumes of lower pressure such that it may not be possible completely to empty the sack during use.

US 2006/0150386 A1 teaches a similar arrangement to that disclosed in the preceding patent application. According to this patent application, a razor is taught in which a flexible bladder comprising shaving agent is located within the handle. Dispensing takes place by squeezing flexible regions of the handle which act directly on the bladder to compress it and expel shaving agent. Once again, dispensing in this manner may result in incomplete emptying of the bladder and a concomitant waste of shaving agent.

Other fluid dispensing razors have also been described. See e.g., U.S. Pat. No. 6,789,321. It would be desirable to provide a fluid-dispensing hair removal device, which is mechanically simple to construct, which does not allow the fluid to come into contact with ambient air or the dispensing mechanism and which permits a more complete dispensing of fluid during use than traditional fluid-dispensing hair removal devices.

### SUMMARY OF THE INVENTION

One aspect of the present invention provides for a hair removal device comprising: a handle; a head positioned on one end of the handle, said hair removal device having a pivot axis about which said head is mounted; one or more orifice(s) in the skin-facing surface of the head are positioned at or close to the pivot axis; a collapsible reservoir suitable for containing a fluid to be dispensed during use of the hair removal device through said one or more orifice(s); an enclosure system selected from a deformable rigid container or a non-deformable rigid container, preferably the device comprises a plurality of orifice(s) wherein one or more of said plurality of orifice(s) are positioned at or close to the pivot axis. Without intending to be bound by theory, it is believed that by placing the orifice(s) at or close to the pivot axis, the device allows the head to rotate and pivot while maintaining a desirable dispensing of the fluid onto skin.

### BRIEF DESCRIPTION OF THE DRAWINGS

FIG. 1 is a perspective view of a hair removal device according to the present invention.

FIG. 2A is a schematic view of a hair removal device according to the present invention, illustrating valves in fluid dispensing mode.

FIG. 2B is a schematic view of a hair removal device according to the present invention, illustrating valves in air intake mode.

FIGS. 3A and 3B represent a detailed view of a particular embodiment of the present invention, illustrating how fluid may flow out of the hair removal device and air may flow in.

FIG. 4 is a perspective view of a hair removal device according to the present invention.

FIG. 5A is a schematic view of a hair removal device according to the present invention, illustrating a pump system in fluid dispensing mode.

FIG. 5B is a schematic view of the hair removal device according to FIG. 2A, illustrating a pump system in fluid intake mode.

FIG. 6A is a schematic view of a hair removal device according to the present invention having an alternative pump actuation mechanism to the hair removal device shown schematically in FIGS. 5A and 5B; in FIG. 6A, pump system is in fluid dispensing mode.

FIG. 6B is a schematic view of a hair removal device according to FIG. 5A, illustrating a pump system in fluid intake mode.

FIG. 7 is a side view of a hair removal device showing the pivot axis extending through the head.

FIG. 8 is a cross side view of a hair removal device showing the pivot axis extending through the head.

FIG. 9 is a cross section side view of a hair removal device of FIG. 8, wherein the head is pivoted about said pivot axis.

### DETAILED DESCRIPTION OF THE INVENTION

Hair removal devices according to the present invention comprise fluid disposed within a collapsible reservoir which reservoir is, itself, enclosed within an enclosure system selected from the group consisting of a deformably rigid container comprising one or more pressure applicators, or a nondeformable rigid container comprising one or more suction devices.

### Enclosure System

In one embodiment the enclosure system comprises a deformably rigid container. The deformably rigid container which encloses the collapsible reservoir must be sufficiently rigid not to collapse at the same time as the collapsible reservoir, although, as discussed below, it can comprise deformable, non-rigid portion(s) as pressure applicator(s). Suitably deformably rigid materials of construction of the deformably rigid container include polyethylene, polypropylene, PET, PVC, and mixtures thereof. The deformably rigid container may be comprised within the handle of the fluid-dispensing hair removal device or, indeed, the handle of the fluid-dispensing hair removal device may itself define the deformably rigid container. If the handle defines the deformably rigid container, then the handle must be sufficiently deformably rigid not only to retain its shape as the collapsible reservoir collapses, but also to function as a handle.

In another embodiment, the enclosure system comprises a non-deformably rigid container. The non-deformably rigid container may be particularly suitable when an actuator and pump are used. The non-deformably rigid container may be comprised within the handle of the fluid-dispensing hair removal device or, indeed, the handle of the fluid-dispensing hair removal device may itself define the non-deformably rigid container. If the handle defines the non-deformably rigid container, then the handle must be sufficiently rigid not only to retain its shape as the collapsible reservoir collapses, but also to function as a handle.

“Deformable”, as defined herein, means that the container body can flex, bend, collapse, or otherwise changes shape when in use. “Non-deformable”, as defined herein, means that the container body does not substantially deform when in use. Those of skill in the art will understand that if sufficient pressure is applied to any container, the container body may be deformed. For the purposes of this invention, deformability is determined with respect to normal usage such as by hand squeezing with a normal grip strength, for example from about 10 PSI to about 80 PSI, or from about 15 PSI to about 40 PSI as determined using a Jamar dynometer. As such, although the non-deformably rigid container does not deform during normal intended use, the container body may be deformed if sufficient pressure is applied.

Those of skill in the art will understand that either type of enclosure system can be used in accordance with the present invention. The term container will be used hereinafter to refer to either or both the deformably rigid container and/ or the non-deformably rigid container, unless otherwise specified.

The collapsible reservoir may be manufactured separately from and then introduced into the deformably rigid container or the two may be manufactured together in a single process.

In one preferred manufacturing process, the two are manufactured together in a single process, such that, following manufacture and prior to use, the collapsible reservoir is removably laminated to the container. An exemplary process includes extrusion blow molding of a multi-layer parison comprising an outer layer, which will become the container, an inner layer, which will become the collapsible reservoir and an intermediate layer, between the inner layer and the outer layer, which serves to prevent the inner and outer layers from permanently adhering to one another. The intermediate layer may extend over the entire interfacial surface between the inner and outer layers, or may be left out at some important locations at the interface, such as at a fluid outlet, in order to effect bonding between the inner and outer layers at that or those locations and thereby prevent delamination in those locations. During the manufacturing process, the multi-layer parison is extruded and then blown. In subsequent use, air forced between the inner and outer layers acts to “delaminate” or peel away the inner layer forming the collapsible reservoir. The collapsible reservoir thereby becomes separated from the outer layer forming the container, while the outer layer enclosing the collapsible reservoir essentially retains its shape.

In an alternative, preferred manufacturing process, injection-moulded inner and outer pre-forms are assembled together and then subsequently blow-moulded to form the collapsible reservoir and the deformably rigid container.

Typical materials of construction of the collapsible reservoir include nylon, PET, PVC, LDPE polypropylene, and mixtures thereof. If the collapsible reservoir and the container enclosing it are made of similar or identical materials, then the necessary differences in rigidity will be achieved in ways known to the skilled person, such as via differences in wall thicknesses. Reference may be made to the following documents which discuss technologies for making so-called “delaminating” or “multi-layer” containers: U.S. Pat. Nos. 5,316,135; 5,447,687; 5,501,625; 6,244,852; 6,109,468; 5,435,452; 5,513,761; 5,567,377; 5,711,454; 5,921,438; 6,691,494; 6,266,943; 6,691,494; 6,266,943; 6,670,007.

Where a deformably rigid container is used, the collapsible reservoir must be contained within the deformably rigid container in such a fashion that any air introduced into the deformably rigid container will serve to pressurize it and collapse the collapsible reservoir, rather than flowing out again. It is desired that air introduced into the deformably rigid container acts to pressurize the contents of the container, as such, in one embodiment the container does not contain any air outlets. As a result in one embodiment, the air inlet comprises a first one-way valve that allows air in but not out. Suitable one-way valves include umbrella or flapper valves and are known to the person skilled in the art.

The fluid comprised within the collapsible reservoir must be allowed to exit the collapsible reservoir and the deformably rigid container for use during the hair removal process. To facilitate this, an opening is provided in the collapsible reservoir and a further opening is provided within the deformably rigid container and these openings are aligned with one another and connected together during the manufacturing process to provide a fluid outlet.

The collapsible reservoir must be connected to the deformably rigid container in such a way at the fluid outlet that air cannot escape from the container. This seal may be effected in a number of ways known by the skilled person. One such way is described above and involves the collapsible reservoir and the deformably rigid container being bonded together during the manufacturing process by virtue of their comprising materials which naturally bond and by virtue of omitting any intermediate layer in the vicinity of the fluid outlet to prevent such bonding. More typically, the collapsible reservoir and the deformably rigid container are arranged such as to be mechanically sealed together at the fluid outlet. For example, the relative sizes of the deformably rigid container and the collapsible reservoir at the fluid outlet may be such that they are forced together. If the collapsible reservoir and the deformably rigid container are manufactured together in a single manufacturing process, then an air-tight seal, such as a mechanical seal, may automatically result from that manufacturing process.

Advantageously, the fluid outlet is provided with a second one-way valve to allow fluid to exit but not enter the collapsible reservoir. This has the advantage of reducing the possibility of contamination of the fluid by contaminated air or by contaminated fluid being drawn back into the collapsible reservoir. Suitable one-way valves include duck-bill valves, flapper valves, slit valves and umbrella valves.

In order to pressurize the air in the deformably rigid container and cause the collapsible reservoir to collapse, the hair removal device must comprise a pressure applicator. In a simple form, when the collapsible reservoir is comprised within the handle, such a pressure applicator may simply comprise deformable portions of the handle. Such deformable portions may suitably be made of plastic or elastomeric material having memory, such that, following deformation from its rest position, it will tend to return to that rest position after removal of the depression force. In use, on depressing such a deformable portion, the air within the deformably rigid container is compressed, serving to collapse the collapsible reservoir and force fluid out of the reservoir for use during the hair removal process. As soon as the user ceases to depress the deformable portion, it returns to its rest position giving rise to an under-pressure within the deformably rigid container, which is compensated by air flowing into the container through the first one-way valve. Hair removal devices according to the invention may comprise one or more pressure applicators. In the event that the hair removal device comprises a plurality of pressure applicators, then the pressure applicators may have different capacities for applying pressure. For example, one pressure applicator may only apply a small pressure, thereby effecting the dispensing of a small amount of fluid, whereas another applicator may apply a larger pressure and effect the dispensing of a larger amount of fluid. The different applicators may also comprise information for the consumer to inform them of the different dispensing capacities.

Ideally, the pressure applicator facilitates the displacement of an accurately repeatable amount of air that ideally corresponds to an accurately repeatable dispensed dosage of fluid from the hair removal device. Such a dosage may be at any desirable level, but is advantageously from 0.001 to 4 ml. A suitable device for displacing the same amount of air each time is a so-called “mono-stable button”. As used herein, a mono-stable button is a button which, when depressed from its rest position, displaces a fixed volume of air, but then returns to its rest position immediately thereafter. In displacing a fixed amount of air, it causes essentially the same amount of fluid to be displaced from the hair removal device. Mono-stable buttons are frequently used on telephone key pads and for pumping fluid and priming liquid systems, such as in petrol engines. Suitable mono-stable buttons are known to those skilled in the art.

Preferably, the pressure applicator(s) will give a signal, such as a tactile signal, for example a click, to the user, that they have been actuated and, therefore, that dispensing shall occur.

In a further advantageous embodiment, the hair removal device may comprise a plurality of pressure applicators disposed at different locations on the handle, to allow the user to grip the handle in a plurality of different ways and yet still facilitate fluid dispensing. For example, a user may grip the handle in an entirely different way if he or she is holding the device vertically or horizontally, or making a long shaving stroke along a leg, or a short one on an under-arm or the face. In order to facilitate simple fluid dispensing in both orientations, the hair removal device may comprise a plurality of pressure applicators at situated different locations, such as on different parts of the handle, so that at least one is always within comfortable range of a user's finger.

Where a non-deformably rigid container is used, the fluid comprised within the collapsible reservoir must be allowed to exit the collapsible reservoir and the non-deformably rigid container for use during the hair removal process. To facilitate this, an opening is provided in the collapsible reservoir and a further opening is provided within the non-deformably rigid container and these openings are aligned with one another and connected together during the manufacturing process to provide a fluid outlet. The collapsible reservoir may be connected to the non-deformably rigid container at the fluid outlet in ways known to the person skilled in the art. One such way is described above and involves the collapsible reservoir and the non-deformably rigid container being bonded together during the manufacturing process by virtue of their comprising materials which naturally bond and by virtue of omitting any intermediate layer in the vicinity of the fluid outlet to prevent such bonding. More typically, the collapsible reservoir and the non-deformably rigid container are arranged such as to be mechanically pressed together at the fluid outlet. For example, the relative sizes of the non-deformably rigid container and the collapsible reservoir at the fluid outlet may be such that they are forced together. If the collapsible reservoir and the non-deformably rigid container are manufactured together in a single manufacturing process, then a mechanical connection may automatically result from that manufacturing process.

Advantageously, the hair removal device according to the invention comprises a first one-way valve in order to allow fluid to exit but not enter the collapsible reservoir. This has the advantage of reducing the possibility of contamination of the fluid by contaminated air or by contaminated fluid being drawn back into the collapsible reservoir. Suitable one-way valves include duck-bill valves, flapper valves, ball valves, slit valves and umbrella valves.

In order to dispense fluid, the hair removal device must comprise a suction device suitable for sucking fluid out of the collapsible reservoir via the fluid outlet. Suitable suction devices are known to the person skilled in the art. Advantageously, the suction device is a pump and preferably an airless pump. As used herein, the term “airless pump” means a pump that can dispense fluid without ingress of air to replace fluid being dispensed. Such pumps have the advantage that they maintain the fluid to be dispensed sterile. Airless pumps are known to the person skilled in the art.

Advantageously, the suction device facilitates the delivery of an accurately repeatable dosage of fluid from the hair removal device. Such a dosage may be at any desirable level, but is advantageously from 0.001 to 4 ml.

One embodiment of an airless pump comprises a chamber having a chamber inlet, through which fluid may enter the chamber, a chamber outlet and a piston which extends across the chamber, the piston having a shaft extending through the chamber outlet in a fluid-tight fashion, wherein a second one-way valve is disposed at the chamber inlet to allow fluid to enter, but not exit the chamber, and the piston comprises a hollow bore, through which fluid may exit the pump, the first one-way valve, referred to above, being located in the bore. Resilient means located on the piston shaft, serve to exert a biasing force biasing the piston towards the chamber outlet.

In use, a depression force is applied by a user to the piston to move it towards the chamber inlet. This, in turn, causes fluid in the chamber to exit the chamber through the hollow bore and out via the first one-way valve. During this phase, the second one way valve is forced shut, so that fluid may not be forced out of the chamber back into the collapsible reservoir. Once the depression force is removed, the resilient means serve to move the piston back towards the chamber outlet, which in turn creates an under-pressure in the chamber, which acts to close the first one-way valve and open the second one-way valve and draw fluid out of the collapsible reservoir and into the chamber.

The means for applying a depression force to the piston may be configured as a button located on the handle of the hair removal device, which button is manually operable by a user of the hair removal device, such that depressing the button directly applies a depression force to the piston shaft.

More preferably, the razor cartridge itself is reciprocally received on the handle, such that the razor cartridge itself is the pump actuator and depressing it effects fluid dispensing. This execution has the advantage of being technically the simplest to realize because neither a button nor a flexible tube linking the pump to the razor cartridge is required. To facilitate easy actuation, a portion of the razor head may be configured as a finger or thumb pad, to render it convenient for a user to apply the necessary depression force. Alternatively, the force applied by the user in bringing the cartridge in contact with and moving it across the skin may be sufficient to depress the cartridge and effect actuation of the pump.

### Head of Device

Once fluid leaves the fluid outlet it enters the head of the hair removal device to be distributed onto the skin of the user. This may take place through one or more orifice(s) in the skin-facing surface of the head.

In one embodiment, the head of the hair removal device comprises an applicator for dispensing the fluid. In one embodiment, the applicator is flat and wide for dispensing a thin but wide ribbon of the fluid. In one embodiment, the applicator forms a dispensing orifice comprising a smaller orifice dimension having a length of from about 0 5 mm to about 10 mm, alternatively from about 1 mm to about 3 mm, and a larger orifice dimension having a length of from about 20 mm to about 80 mm, alternatively from about 30 mm to about 70 mm, alternatively from about 40 mm to about 50 mm Preferably, the smaller orifice dimension is a vertical dimension and the larger orifice dimension is a horizontal dimension. The smaller and larger orifice dimensions are measured as the vertical and horizontal distances, respectively between opposing edges of the applicator which forms the orifice. This type of applicator is particularly suitable when the device contains a depilatory, a lubricating fluid, a moisturizer, or any other suitable hair removal composition. In one embodiment, the applicator has a spreading member which is separate from the dispensing orifice. When a spreading member is used, the device can dispense the fluid via one or more orifice(s) which can be positioned proximally towards the handle (where the spreading member is positioned distally away from the deformably rigid container) such that when the user is pulling the device in a direction towards the handle, fluid can be dispersed and the spreading member can be used to spread the fluid onto the skin surface. In one embodiment, the spreading member has a length of from about 20 mm to about 80 mm, alternatively from about 30 mm to about 70 mm, alternatively from about 40 mm to about 50 mm.

In one embodiment, the applicator has a skin contacting edge which is flat, concave or convex. Those of skill in the art will understand that different shapes for the skin contacting edge can be preferred based on the desired part of the body upon which the device is intended for use. For example, a hair removal device intended for use on the face may have an applicator having a straight edge. A hair removal device intended for use on legs may have an applicator having a concave edge. Non-limiting examples of suitable head configurations are disclosed in U.S. Design Patent Nos. D399,601 to Desnos, D203,892 to Muscatiello, and 651,420 to Haglock; U.S. Pat. No. 3,088,470 to Hall, U.S. Pat. No. 3,858,985 to Fiveash, 2004 0168743A1 to Garwood; WO Publ. No. 97/18043A1 to Weiss; and GB 1 390 153 to Laboratorio Guidotti & C. S.p.A.

Those of skill in the art will understand that the applicator can also serve as a dispensing member for a second fluid. In one embodiment, the applicator would include a slit type orifice which could remain in a closed orientation until pressure is applied, opening the slit type orifice and allowing fluid to dispense.

### Pivot Axis

In one embodiment, the hair removal device comprises a pivot axis about which the head is mounted. In one embodiment, the one or more orifice(s) in the skin-facing surface of the head are positioned at or close to the pivot axis. Said one or more orifice(s) allow fluid to be discharged directly to the skin at or near the predetermined pivot axis. The orifice(s) can be formed from an applicator which may extend away from the head, or can be formed by the material forming the head itself. Non-limiting of devices having similar placement of the discharge positions of fluid are available in U.S. Pat. No. 6,789,321. In one embodiment the device comprises a plurality of orifice(s) wherein one or more of said plurality of orifice(s) are positioned at or close to the pivot axis. Said one or more of orifice(s) can generally form a line extending for a portion of said pivot axis. The device could also have just one orifice which has a generally elongated shape extending side ways towards the lateral ends of the head of the device, extending for a portion of the pivot axis. By providing one or more orifice(s) positioned along a portion of any fluid dispensed at the pivot axis would have a greater chance of forming a thin but wide ribbon of the fluid. Non-limiting examples of suitable orifices are provided herein and also available in U.S. Provisional Application filed on Mar 15, 2010, entitled HAIR REMOVAL DEVICE, Attorney's Docket No. Z-8441P, to Terence Gordon Royle et al. (U.S. Ser. No. 61/340,299).

By arranging the fluid to be discharged through said one or more orifice(s) located on or very near the pivot axis of the head, the discharge can occur essentially at the same location. For example where the device is a razor, at a guard surface in front of the blade or blades, irrespective of the pivotal movements of the blade unit. This result can be achieved with the orifices being defined by a part of the device which remains stationary with the respect to the head which can rotate about the pivot axis. In addition, a direct mechanical connection between the stationary part of the device (i.e. the handle and container), which may conveniently be constituted by a flexible tube, and any replaceable portion of the head (such as a replaceable razor cartridge) is not needed, which can simplify head/cartridge replacement.

The head is preferably provided with a channel, which can be open continuously along the length thereof, for distributing fluid delivered through the discharge port across the head in the direction of the pivot axis. The channel can be at least partly defined by an elastomeric skin contacting element having a lip which surrounds and seals against the delivery tube adjacent the orifice(s).

In accordance with another aspect the invention resides in a hair removal device which is mounted or mountable for pivotal movement relative to the handle, an opposite end of the head carrying structure being hingedly connected to a supporting structure, a delivery system for conducting a fluid to the orifice(s) from a reservoir, the delivery system including a valve for controlling supply of fluid to the orifice(s), the head carrying structure being coupled to the valve for the valve to be actuated by displacement of the blade unit carrying structure relative to the supporting structure caused by pressing the head against the skin during shaving, and the head carrying structure being resiliently biased to close the valve when the blade unit is lifted clear of the skin.

A preferred hair removal device according to the invention embodies both aspects described above. For example, where the device is a razor, by the valve being actuated by movement of the blade unit carrying structure brought about by pressing the blade unit against the skin it can be ensured that fluid is delivered precisely when and where it is needed or desired, such as immediately in front of the blade(s) of the blade unit, and the user is not required to perform any additional operation in order to open the control valve. Nonetheless, the blade unit carrying structure can be adapted also to allow direct manual operation of the control valve by the user to provide for greater flexibility in use. The blade unit carrying structure is conveniently movably connected to a supporting structure, more especially integrally hingedly coupled to the supporting structure by one or more flexible webs. The reservoir is preferably constituted by a container to which the supporting structure, conveniently having the form of a ring, is attached, for example by friction or a snap-fit connection with a rim of the container. The blade unit carrying structure may comprise a hollow stem extending upwardly from a flange-like base which is connected to the supporting ring by a pair of laterally opposed web hinges and the base can define a finger button at which the base can be engaged and be depressed by a finger of the user to open the valve.

The handle of the hair removal device may be permanently or removably fixed to the hair removal device. Advantageously, the handle is detachable from the hair removal device. If the handle comprises the deformably rigid container enclosing the collapsible reservoir, then such an arrangement facilitates replacement of the collapsible reservoir. In such a case, if the reservoir is empty, then the handle, comprising the deformably rigid container and collapsible reservoir are simply removed and replaced by a new handle comprising a deformably rigid container enclosing a new collapsible reservoir which is full of fluid. The empty handle can then be recycled.

The fluid-dispensing hair removal device according to the invention may be a shaving device, such as a razor, but is not limited to such devices and may instead be a device which employs other means, such as light, especially laser light, or even depilatories (as disclosed in U.S. Pat. Nos. 4,618,344. 5,645,825A, 6,743,419, and US Patent Publication US2004/0228820A1), to remove hair. In one embodiment, the hair removal device comprises at least one of a razor, a scraping edge or scraper, a light, and a depilatory, optionally more than one. Like the spreading edge, the scraper or scraping edge can be straight, concave or convex shaped.

For the event that the hair removal device is a razor, then the razor cartridge comprising the blades may be permanently or removably fixed to hair removal device. Advantageously, the cartridge is detachable from the hair removal device, such that it may be replaced, as needed.

The fluid comprised within the reservoir of the hair removal device is advantageously a cosmetic fluid, more preferably a shaving preparation. Examples of such fluids include, but are not limited to; oil-in-water emulsions, water-in-oil emulsions, single phase aqueous polymer solutions, high level surfactant based solutions. Within such fluids, additional ingredients may be incorporated, examples of which include: high molecular weight polymers, cationically charged polymers, lipid based materials, silicone based compounds, surfactants, vitamins and vitamin derivatives, skin conditioning agents, hair removal waxes, other hair removal compositions, and depilatories.

### Figures

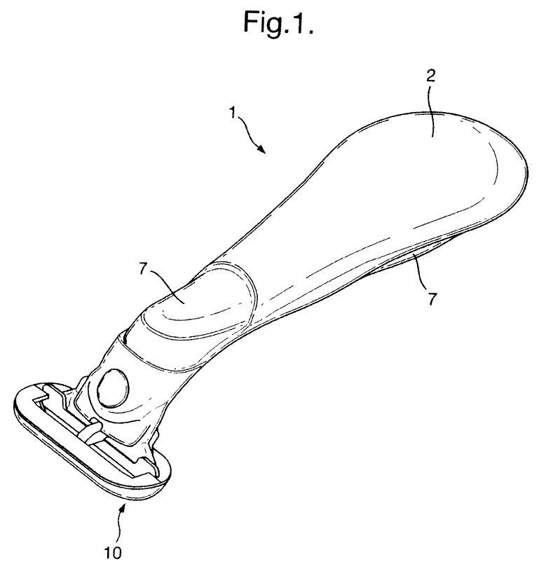

Reference is made to the figures, which disclose a non-limiting embodiment of the invention. FIG. 1 illustrates a hair removal device (1) is disclosed in the form of a razor, having a shaving cartridge (10) comprising blades (not shown). The razor comprises a handle (2) which acts as the deformably rigid container (4) enclosing a collapsible reservoir, which, in turn, contains fluid, such as shaving aid, to be dispensed. Pressure applicators (7) may also be seen, which are configured as flexible portions of the handle (2). These pressure applicators (7) may be depressed by a user to pressurize the air space in the handle and thereby also the collapsible reservoir (3), thereby forcing fluid out of the collapsible reservoir (3).

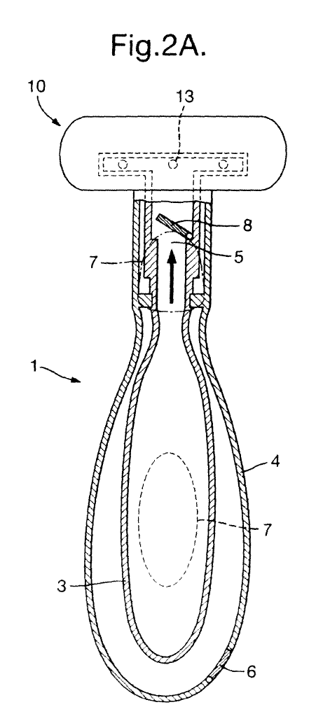

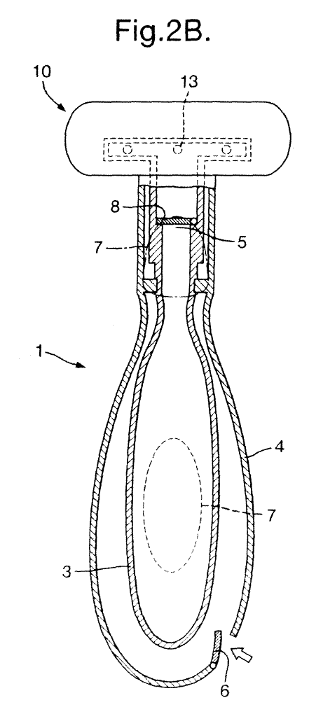

FIGS. 2A and 2B are schematic drawings, illustrating some important functional aspects of the hair removal device (1) of FIG. 1.

FIG. 2A illustrates the deformably rigid container (4), which may also be the handle, which encloses the collapsible reservoir (3). Pressure applicators (7) may also be seen. These are configured as flexible portions of the handle which have memory. In use they may be depressed on application of force by a user. Following removal of the applied force, they return to their rest state. Importantly, first one-way valve (6) is also shown, which functions to allow air to enter the deformably rigid container (4) but not exit. In FIG. 2A, this valve is shut, because the device is in fluid-dispensing mode. As a result, fluid contained within the collapsible reservoir is being expelled (as indicated by the arrow) through fluid outlet (5) via second one-way valve (8), which is open. This has been effected by depressing, one or more of the pressure applicators (7) to compress the air in deformably rigid container (4) and thereby also compress the collapsible reservoir (3). This, in turn, causes fluid contained within the collapsible reservoir to be expelled via fluid outlet (5).

The features shown in FIG. 2B are identical to those shown in FIG. 2A, except that this figure illustrates the valves in air-intake mode: following release of the force applied by the user, the pressure applicator (7) returns to its rest state, thereby generating an under-pressure in the deformably rigid container (4), which, in turn, serves to draw air in via first one-way valve (6), as shown by the arrow, to allow the pressure to equilibrate within the deformably rigid container (4). As a result, first one-way valve (6) is shown open in this figure, whereas the absence of pressure on second one-way valve (8) has caused it to close, as shown.

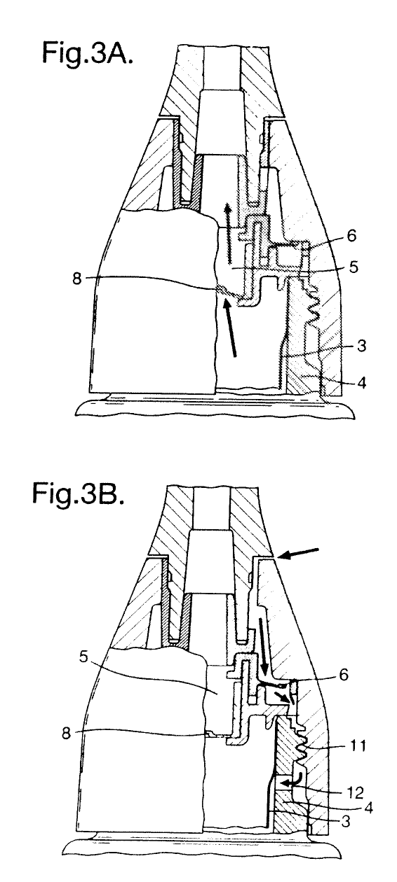

FIGS. 3A and 3B illustrate a working embodiment of a valve system shown schematically in FIG. 2. The collapsible reservoir (3) and the deformably rigid container (4) are shown. With reference to FIG. 3A, in response to a pressure increase in the deformably rigid container (4), fluid flows in the direction shown by the arrows through the fluid outlet (5), which is equipped with second one-way valve (8) to prevent fluid re-entry. Air may not flow into the deformably rigid container (4), because first one-way valve (6) is forced shut by the increased pressure. With reference to FIG. 3B, in response to a pressure decrease in the deformably rigid container (4), second one-way valve (8) is forced shut, but first one-way valve (6) opens to allow air to flow in the direction of the arrows. There is an air gap (not shown) through threaded portion (11) to allow air to flow through an opening (12) and thereby into the space between the collapsible reservoir (3) and the deformably rigid container (4).

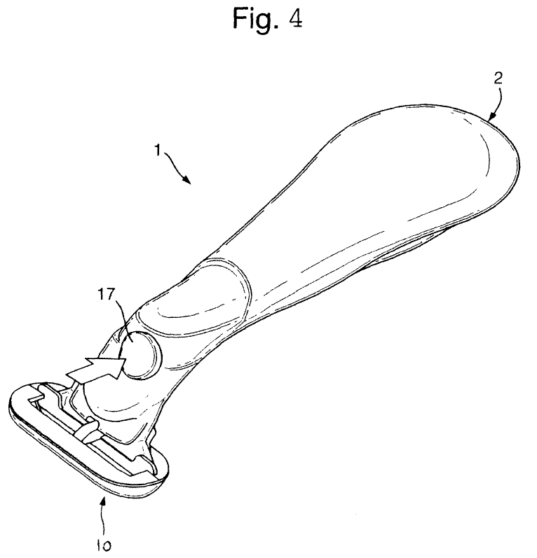

FIG. 4 illustrates another hair removal device (1) in the form of a razor, comprising a handle (2) and a razor cartridge (18), itself comprising blades (not shown), and a button (17) for dispensing fluid, wherein the hair removal device has a non-deformable rigid container.

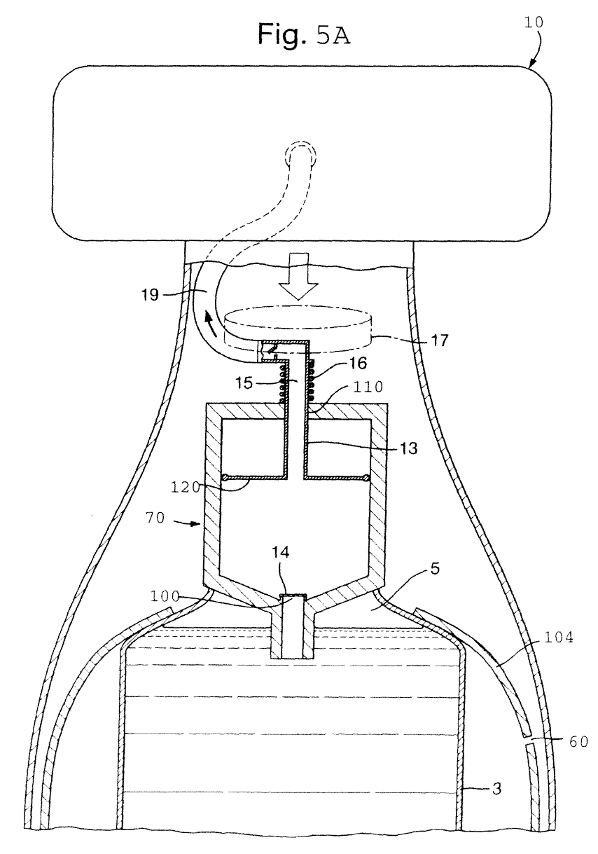

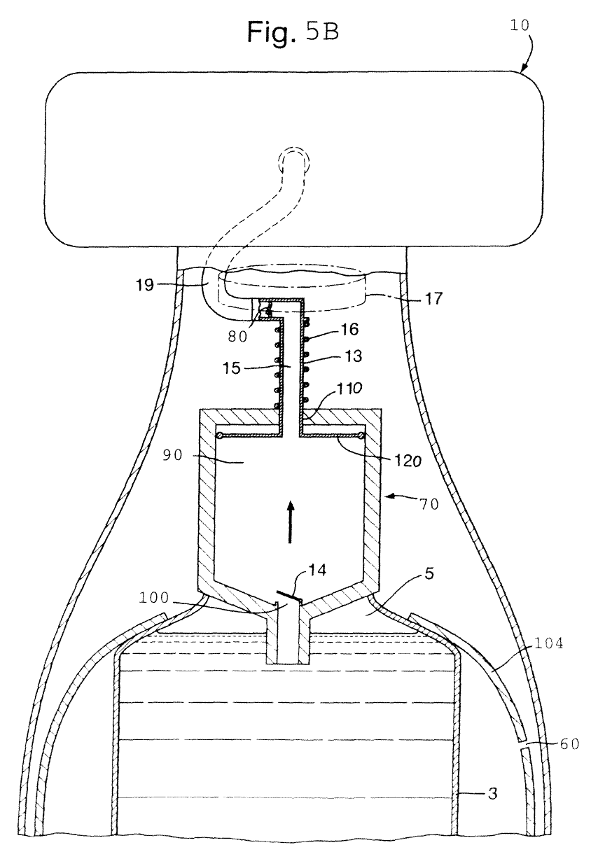

FIGS. 5A and 5B are schematic drawings, illustrating one way of executing the embodiment shown in FIG. 4. These figures show a flexible reservoir (3) comprising a fluid, the reservoir being enclosed by a container (104), both the flexible reservoir (3) and the container (104) having aligned openings which, together, form a fluid outlet (5) through which fluid may exit the collapsible reservoir (3) and container (104). One or more orifice(s) (60) in the container (104) allow air to flow into the container, thereby permitting pressure compensation as the collapsible reservoir (3) collapses.

FIGS. 5A and 5B also show a suction device (70) which is configured, in this case, as an airless pump. The airless pump comprises a chamber (90) having a chamber inlet (100), through which fluid may enter the chamber (90), a chamber outlet (110) and a piston (120) which extends across the chamber (90), the piston (90) having a piston shaft (13) extending through the chamber outlet (110) in a fluid-tight fashion, wherein a second one-way valve (14) is disposed at the chamber inlet (100) to allow fluid to enter, but not exit the chamber. The piston comprises a centrally located piston orifice to allow fluid to pass through the piston. In addition, the piston shaft (13) comprises a hollow bore (15), which is fluidly connected to the piston orifice such that fluid may flow through the piston orifice, into the hollow bore (15) and exit the pump. A first one-way valve (80) is located in the hollow bore (15) to allow fluid to exit but not re-enter the hollow bore (15). Resilient means (16) located on the piston shaft (13); serve to exert a biasing force biasing the piston (120) towards the chamber outlet (100). The resilient means are configured as a coil spring in these figures, but may, alternatively, be configured in alternative ways known to the person skilled in the art.

The airless pump may be actuated by applying a depression force to button (17), shown in dotted lines, to expel fluid from the airless pump, through first one-way valve (80) and into flexible tube (19), which connects the airless pump with the razor head (180), from which it is dispensed onto the skin of the user. This may take place through one or more orifice(s) (not shown) in the skin-facing surface of the head.

In use, a depression force is applied by a user to button (17), which transmits the force via piston shaft (13) to piston (120) to move it towards the chamber inlet (100). This, in turn, causes fluid in the chamber (90) to exit the chamber (90) through the hollow bore (15) of the piston shaft (13) and out via the first one-way valve (80). During this phase, the second one way valve (14) is forced shut by the depression force exerted by piston (120) and transmitted through the fluid, so that fluid may not be forced out of the chamber back into the collapsible reservoir (3). Once the depression force is removed, the resilient means (16) serve to move the piston (120) back towards the chamber outlet (110). This, in turn, creates a pressure drop in the chamber (90), which acts to close the first one-way valve (80) and open the second one-way valve (14) and draw fluid out of the collapsible reservoir (3) and into the chamber (90) to replenish it in readiness for the next actuation of the pump. As the collapsible reservoir (3) collapses, air is drawn into the container (104) via orifice(s) (60) to compensate for the reduced volume of the collapsible reservoir (3).

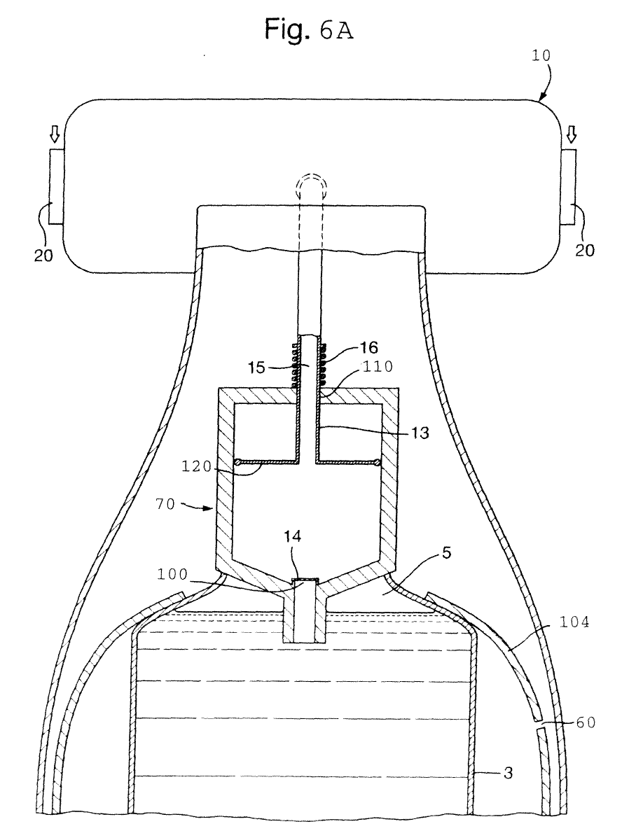

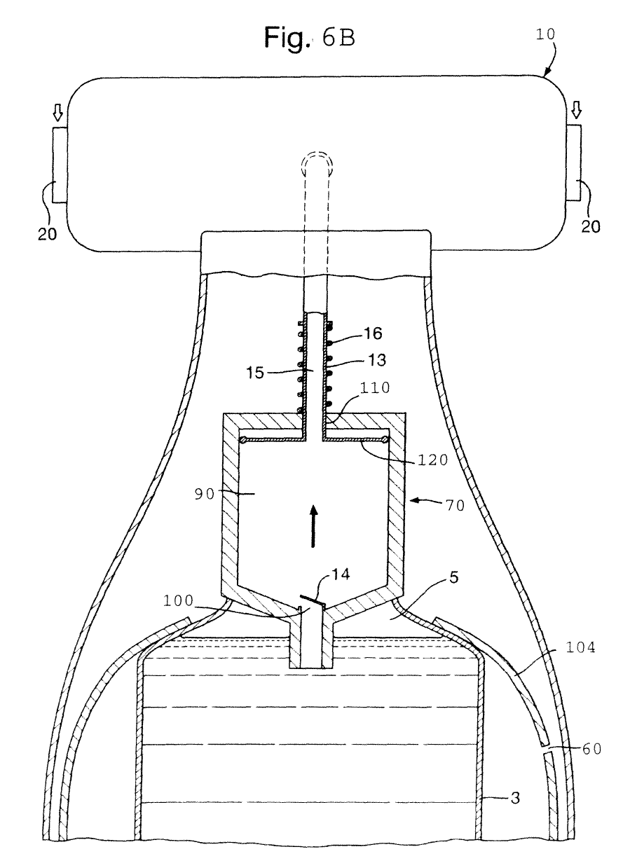

FIGS. 6A and 6B are schematic drawings illustrating an alternative way of actuating the suction device (70). Numbered features in these figures are the same and have the same function as features having the same number in FIGS. 5A and 5B. The difference between the embodiment of FIGS. 5A and 5B on the one hand and FIGS. 6A and 6B on the other is that actuation of the pump is not effected by a depressing a button, but by movement of the razor cartridge (180) itself, which is reciprocally received on the handle.

In use of the embodiment of FIGS. 6A and 6B, a depression force is applied by a user to the cartridge (180) to overcome the biasing force of resilient means (16) and depress the cartridge (180) from its rest state. This depression force may be applied essentially as shown by the force arrows depicted in FIG. 6A to finger/thumb pads (20). Alternatively, the force applied by the user in bringing the cartridge (180) into contact with and moving it across the skin may be sufficient to overcome the biasing force of resilient means (16) and depress the cartridge (180) from its rest state. Depression of cartridge (180) transmits an axial force via piston shaft (13) to piston (120) to move it towards the chamber inlet (100). This, in turn, causes fluid in the chamber (90) to exit the chamber (90) through the piston orifice and hollow bore (15) of the piston shaft (13) and out via the first one-way valve (not shown). During this phase, the second one way valve (14) is forced shut by the depression force exerted via piston (120) and transmitted through the fluid, so that fluid may not be forced out of the chamber back into the collapsible reservoir (3). Once the depression force is removed, as shown in FIG. 6B, the resilient means (16) serve to move the cartridge (180) back to its rest state, during which piston (120) is urged back towards the chamber outlet (110). This, in turn, creates a pressure drop in the chamber (90), which acts to close the first one-way valve (not shown) and open the second one-way valve (14) and draw fluid out of the collapsible reservoir (3) and into the chamber (90) to replenish it in readiness for the next actuation of the pump. An advantage of this embodiment versus embodiments such as that depicted in FIGS. 5A and 5B is that it is technically simpler, requiring no separate button and no flexible tubing linking the razor cartridge with the pump.

FIG. 7 is a side view of a hair removal device showing the pivot axis (100) extending through the head (18). The head is attached to the handle (2) but capable of rotational movement around the pivot axis (100).

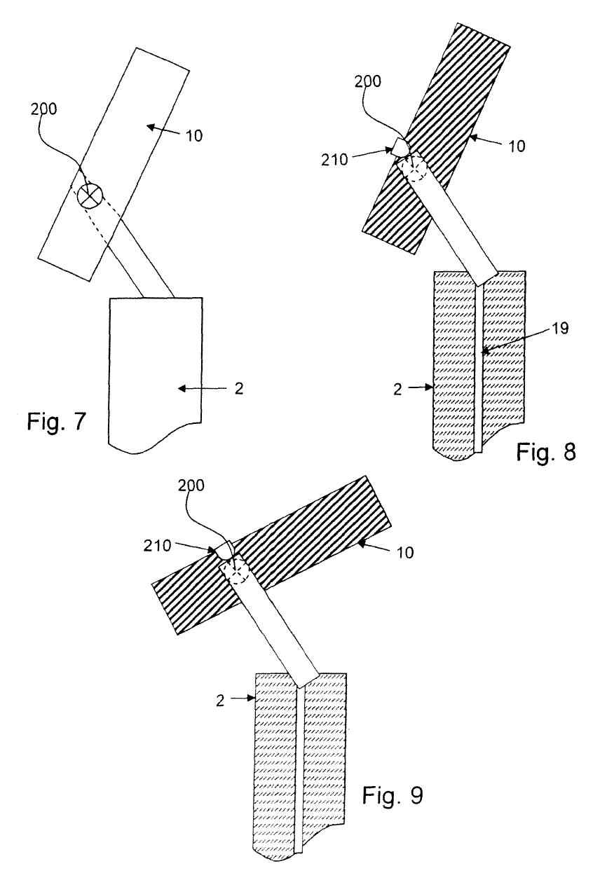

FIG. 8 is a cross side view of a hair removal device showing the pivot axis (100) extending through the head (18). One or more orifice(s) (110) in the skin-facing surface of the head are positioned at or close to the pivot axis (100). Also shown in FIG. 8 is a flexible hose (19). FIG. 9 is a cross section side view of a hair removal device of FIG. 8, wherein the head (18) is partially rotated about said pivot axis (100). One or more orifice(s) (110) in the skin-facing surface of the head are positioned at or close to the pivot axis (100)/

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern.

Except as otherwise noted, the articles “a,” “an,” “and ” “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hair removal device comprising:
a. a handle;
b. a head positioned on one end of the handle, said hair removal device having a pivot axis about which said head is mounted;
c. one or more orifice(s) in the skin-facing surface of the head are positioned at or close to the pivot axis;
d. a collapsible reservoir suitable for containing a fluid to be dispensed during use of the hair removal device through said one or more orifice(s);
e. an enclosure system selected from the group consisting of:
i. a deformably rigid container enclosing the collapsible reservoir, a fluid outlet adapted to allow fluid to exit both the collapsible reservoir and the deformably rigid container; a first one-way valve adapted to allow air to enter but not exit the deformably rigid container; and a pressure applicator, adapted to pressurize air in the deformably rigid container, thereby collapsing the collapsible reservoir and causing fluid to be expelled through the fluid outlet; and
ii. a non-deformably rigid container enclosing the collapsible reservoir, a fluid outlet adapted to allow fluid to exit both the collapsible reservoir and the non-deformably rigid container, an orifice adapted to allow air to flow in or out of the container, and a suction device, adapted to suck fluid out of the collapsible reservoir through fluid outlet.

2. The hair removal device of claim 1, wherein said head forms more than one of said orifice(s).

3. The hair removal device of claim 2, wherein said more than one of said orifice(s) are positioned along said pivot axis.

4. The hair removal device of claim 1, wherein not all of said orifice(s) are positioned along said pivot axis.

5. The hair removal device of claim 1, wherein said head further comprises an applicator for dispensing the fluid, wherein said applicator forms said one or more orifice(s).

6. The hair removal device of claim 1, wherein said head further comprises a skin contacting edge.

7. The hair removal device of claim 5, wherein said applicator forms said skin contacting edge.

8. The hair removal device of claim 1, wherein the handle forms the enclosure system.

9. The hair removal device of claim 8, wherein the enclosure system consists of the deformably rigid container and the device additionally comprise a second one-way valve disposed at fluid outlet, to allow fluid to exit but not enter the reservoir.

10. The hair removal device of claim 9, wherein the pressure applicator is defined by one or more deformable portions of the handle, whereby depressing a deformable portion away from its rest position acts to pressurize the air disposed in the deformably rigid container and releasing the deformable portion causes it to return to its rest position and draw air through the first one-way valve into the deformably rigid container.

11. The hair removal device according to claim 9, wherein the pressure applicator comprises a dosing mechanism, to ensure that the same amount of air is displaced and a dose of fluid is dispensed every time pressure is applied.

12. The hair removal device of claim 9, wherein the pressure applicator comprises one or more mono-stable buttons, whereby depressing a mono-stable button acts to pressurize the air by a defined amount to ensure that a dose of fluid is dispensed every time that the mono-stable button is depressed and releasing the mono-stable button causes it to return to its rest position and draw air through the first one-way valve into the deformably rigid container.

13. The hair removal device of claim 1, wherein enclosure system consists of the non-deformably rigid container and wherein the suction device is a pump.

14. The hair removal device of claim 13, wherein the device is a razor having a razor cartridge comprising one or more razor blades, the suction device is a pump and the razor cartridge reciprocally received on the handle, such that applying a depression force to depress the razor cartridge from its rest state actuates the pump and dispenses fluid onto the skin of a user, and whereby a biasing means acts to return the razor cartridge to its rest state once the depression force has been removed.

15. The hair removal device of claim 14, wherein the biasing force exerted by the biasing means is adapted to be overcome by the force exerted by a user in bringing the cartridge into contact with and moving it across the skin.

16. The hair removal device of claim 16, wherein the pump is manually powered.

17. The hair removal device of claim 1, wherein the fluid comprises a shaving preparation.

18. The hair removal device of claim 1, wherein the fluid comprises a depilatory.

19. The hair removal device of claim 1, wherein the head comprises a skin contacting edge which is selected from the group consisting of a flat edge, a concave edge, and a convex edge.

20. The hair removal device of claim 1, wherein the device is a razor having a razor cartridge comprising one or more razor blades.
